(19) United States
(12) Patent Application Publication
(10) Pub. No.: US 2010/0180962 A1
(43) Pub. Date: Jul. 22, 2010

(54) VACUUM RELIEF ASSEMBLY WITH CONTAMINANT SCREEN

(76) Inventors: Alex V. Degutis, East Chicago, IN (US); Peter J. Gubricky, Crest Hill, IL (US); William R. Borowski, Palos Park, IL (US); James M. McLaughlin, Monee, IL (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6731, US

(21) Appl. No.: 12/355,448

(22) Filed: Jan. 16, 2009

(51) Int. Cl. F16K 17/00

(52) U.S. Cl. 137/526

(57) ABSTRACT

A vacuum relief assembly for a containment vessel. The vacuum relief assembly includes a normally closed vacuum activated valve that selectively permits flow into the containment vessel from the atmosphere through an interior passage. The valve body includes an inlet opening into the interior passage and an outlet opening normally closed by the valve. A screen member is disposed upstream of the inlet opening. The screen is cylindrical and is supported between a shoulder on the valve body and a cap secured to the valve body.

### TECHNICAL FIELD

The present invention is directed generally to vacuum relief assemblies for containment vessels. More particularly, it is directed to vacuum relief assemblies which protect against contamination by airborne contaminants.

### BACKGROUND OF THE INVENTION

Containment vessels may be used to store and/or transport a wide range of materials including chemicals, foodstuffs and the like. Common forms of containment vessels are railway tank cars or highway tank trucks. Such vessels are generally operated at an interior pressure that is neutral or slightly positive relative to outside atmospheric pressure. These vessels, however, are typically not well suited to withstand vacuum conditions wherein the pressure at the interior of the tank car drops significantly below exterior atmospheric pressure.

To address the avoidance of vacuum conditions within a tank car or other containment vessel, it is generally known to utilize vacuum relief valves that open selectively to deliver air from the atmosphere into the interior of the vessel when the internal pressure drops below a predetermined level. This introduction of air is carried out by opening a normally closed flow path between the atmosphere and the vessel interior. Upon opening the flow path, air is pulled from the atmosphere into the vessel interior until the pressure differential is substantially eliminated. The flow path is thereafter closed until vacuum conditions reoccur. An example of such a vacuum relief valve is a valve available from Salco Products, Inc., Lemont, Ill.

While such systems are quite effective, the opening of the flow path may present an opportunity for contamination of the lading within the vessel by insects or other airborne particulates.

### BRIEF SUMMARY OF THE INVENTION

A vacuum relief assembly for a containment vessel is provided. The vacuum relief assembly includes a pressure activated vacuum relief valve including a valve body defining a flow path. The valve is adapted to be selectively opened to provide fluid communication from the atmosphere to the interior of a containment vessel. A screen member is disposed upstream of the inlet opening of the flow path to block ingress of airborne debris.

### BRIEF DESCRIPTION OF THE DRAWINGS

The following drawings illustrate exemplary embodiments and constructions of the present invention and, together with the general description given above and the detailed description set forth below, serve to explain the principles of the invention wherein:

FIG. 1 illustrates an exemplary containment vessel in the form of a railroad tank car including a vacuum relief assembly;

FIG. 2 is an exploded view of an exemplary vacuum relief assembly illustrating an embodiment according to the present invention;

FIG. 3 is a cross-sectional view of the interior of the valve body of FIG. 2 taken generally along line 3-3 of FIG. 2; and

FIG. 4 is a sectional plan view of a vacuum relief assembly embodying principles of the present invention in assembled condition attached to a flange plate of a containment vessel.

### DETAILED DESCRIPTION OF ILLUSTRATED EMBODIMENT

Reference will now be made to the drawings wherein, to the extent possible, like reference numerals are used to designate like elements throughout the various views.

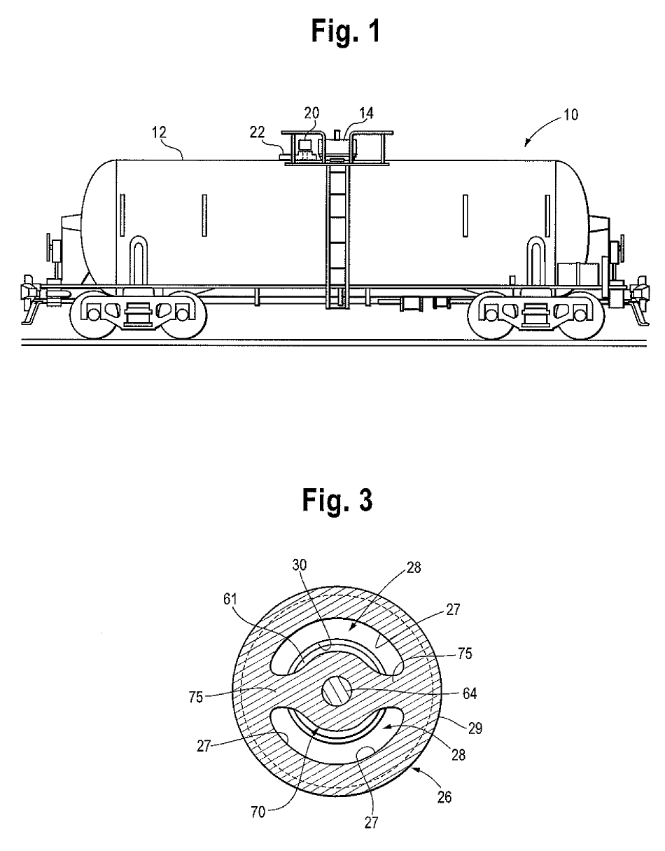

FIG. 1 illustrates a containment vessel in the form of an exemplary railroad tank car 10. As will be appreciated, the tank car 10 includes a containment shell 12 which is typically formed from steel or other structural material defining an interior storage chamber adapted to hold a cargo which may be liquid or particulate solids. The interior storage chamber may be accessed via a hatch structure 14 which may be opened and closed by an operator. During transportation of the tank car 10, the hatch structure 14 normally remains closed and locked to prevent contamination or spillage of the cargo.

The illustrated tank car 10 includes a flange plate 20 disposed across a surface of the containment shell 12. It includes a threaded opening into the interior chamber of the shell 12 adapted to accept a vacuum relief assembly 22.

The vacuum relief assembly 22 defines a flow path to allow air into the interior storage chamber in the event that vacuum conditions develop within the interior storage chamber. The path is otherwise closed when atmospheric pressure and the pressure within the chamber are balanced.

In the illustrated arrangement, the vacuum relief assembly 22 is secured to the flange plate 20 within the threaded opening. It is, however, contemplated that the vacuum relief assembly 22 may be disposed at an opening within the containment shell 12 or at the hatch structure 14 or other suitable portion of the tank car 10.

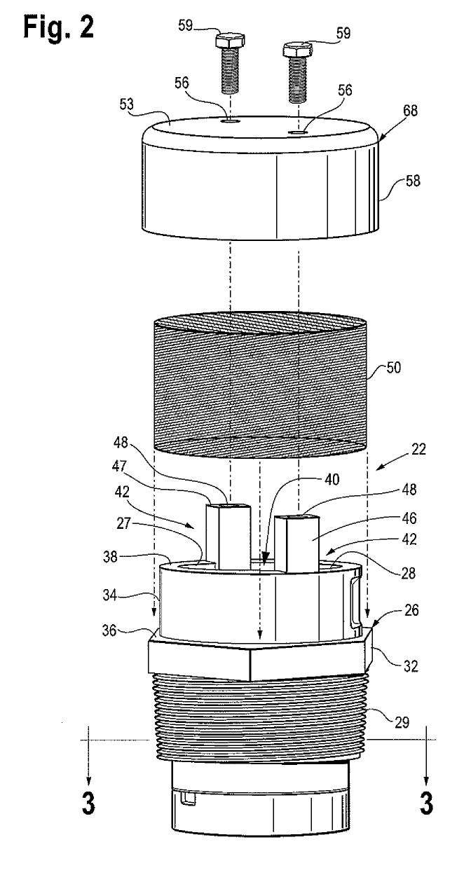

One exemplary construction of the vacuum relief assembly 22 is illustrated in FIGS. 2-4. The vacuum relief assembly 22 includes a hollow valve body 26 formed from steel or other metal. Valve body includes interior wall surface 27 that defines an open interior passage 28. The lowermost end of the valve body defines an outlet opening 30 surrounded by conical valve seat 31.

The valve body 26 includes a lower end defining a securement portion. It includes threads 29 adapted to engage threads in the opening within the flange plate 20. The threads are illustrated as pipe threads (NPT) a common method of attachment. It is contemplated, however, that valve body 26 may include a bolt flange rather than a threaded end. In that instance the flange plate 20 would include a hole, opening into the interior of the shell 12 of vessel 10 and threaded studs arranged about the hole to receive the bolt flange of the valve body 26.

In order to facilitate threaded engagement, the illustrated valve body 26 includes a hexagonally shaped flange 32 to accept a wrench. It would, however, have any other commonly used torque-acceptance configuration to receive a tool to tighten or loosen the valve body 26 relative to the flange plate 20.

As shown, a shoulder surface 36 faces upwardly away from the flange 32. As best illustrated in FIG. 2, a generally annular upper sidewall 34 extends upwardly from the shoulder surface 36. Annular upper sidewall 34 has a top edge surface 38.

In the illustrated construction, mounting posts 46 project upwardly from the upper edge surface 38 of the upper sidewall 34 and define the upper end of the valve body 26. Each has a top surface 47 provided with a threaded hole 48. The mounting posts 46 are preferably integral with the upper sidewall 34 although they may be formed separately if desired. The outboard surface of the mounting posts 46 is preferably generally aligned with the outer surface of the annular upper sidewall 34. The arcuate open spaces 42 between the posts 46 define an inlet opening 40 with access to the atmosphere surrounding the vacuum relief assembly 22. The flow inlet opening 40 provides an open fluid communication path to the atmosphere and interior passage 28 of the valve body 26.

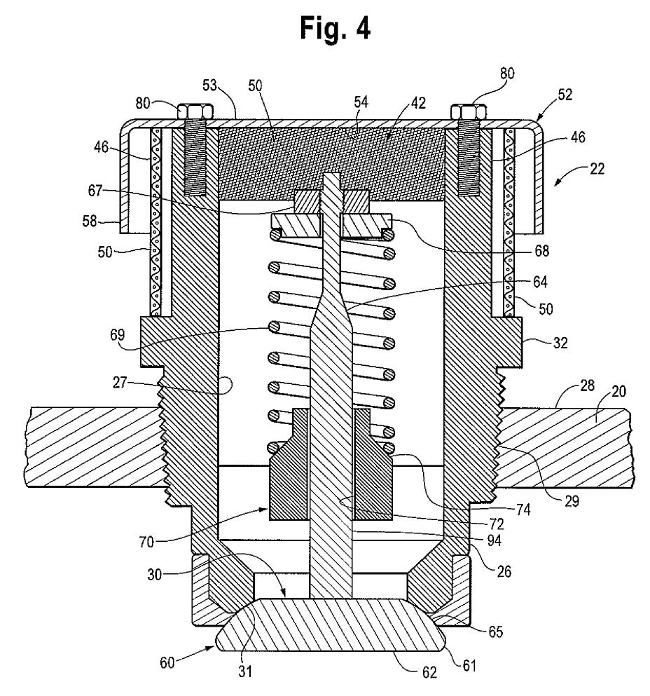

As best understood through reference to FIGS. 3 and 4, in the illustrated arrangement, the valve body 26 includes an annular valve guide 70 defining a valve guide surface 72. It also defines a spring support shoulder 74. Valve guide 70 is supported by radial webs 75 projecting inwardly from the interior wall 27 of the valve body 26 that defines passage 28. The webs 75 are spaced around the interior of the valve body 26 such that air can flow through the passage from the inlet opening 40 defined by the open spaces between mounting posts 46 through passage 28 and through the outlet opening 30 defined by conical valve seat 31.

As illustrated in FIG. 4, the interior passage 28 is normally sealed against fluid communication with the interior of the tank car 10 by a movable valve 60. Valve 60 includes a head 61 that defines a conical seat surface 65 that seals against conical valve seat 31 on valve body 26 to close passage 28 against flow. A face surface 62 is exposed to the interior of containment shell 12.

Head 61 is connected to elongate valve stem 64 extending axially of the interior passage 28 and slidable within guide surface 72. Its free end is threaded and receives a nut 67 that limits the position of a valve bushing 68 disposed at an upper end of the stem 64 remote from the valve head 61. A compression spring member 69 is held in a compressed condition between the valve bushing 68 and the spring support shoulder 74. As will be appreciated, such an arrangement continuously urges the valve stem 64 and head 61 upwardly to a sealing position with conical seat 65 sealed against conical seat 31 of body 26 as shown. In this normally closed position, fluid communication through outlet opening 30 is blocked between the interior passage 28 and the interior of the tank car 10.

In the event that the valve 60 is subjected to a downward force due to the occurrence of a negative pressure at the face surface 62, the valve 60 overcomes the biasing force provided by the spring member 69 and moves away from the illustrated sealing relation with seat 31 thereby establishing fluid communication between the interior of the tank car 10 and the interior passage 28 of valve body 26. Since the interior passage 28 is open to the atmosphere at communication paths defined by inlet opening 40, fluid communication is established between the interior of the tank car 10 and the atmosphere. Accordingly, due to a low pressure condition within the tank car 10, air flows from the atmosphere, through the interior passage 28 and into the interior of the tank car 10. This flow path remains open until the vacuum condition within the tank car is reduced to a level permitting the valve 60 to return to the normally closed and sealed condition.

As illustrated in FIGS. 2 and 4, in accordance with the present invention a mesh screen member 50 is disposed in sleeve-fitting covering relation to the upper sidewall 34 and the mounting posts 46. The screen member 50 is of substantially hollow cylindrical construction and may be formed from metal or plastic mesh or other suitable material. By way of example only, stainless steel or other corrosion resistant materials may be particularly beneficial.

The screen member 50 of cylindrical construction is characterized by an inner diameter that is slightly larger than the outer diameter of the upper sidewall 34 and the mounting posts 46 to permit sliding insertion of the upper sidewall 34 into the interior of the screen member 50. The outer diameter of the screen member 50 is also less than the outer diameter of shoulder surface 36 provided by the hexagonally shaped flange 32 disposed below the upper sidewall 34 such that the shoulder surface 36 provides a support platform for the screen member 50. The height of the screen member 50 is substantially the same as the distance between the shoulder surface 36 and the top surfaces 47 of the mounting posts 46 defining inlet opening 40. The screen member 50 resides around the upper sidewall 34 and the mounting posts 46 in covering relation to the open spaces 42 between the mounting posts 46. Thus, screen member 50 is positioned upstream of the flow inlet opening 40. That is, air passing through the spaces 42 defining inlet opening 40 must first pass through the mesh of screen member 50.

In the illustrated arrangement best seen in FIGS. 2 and 4, a cap 52 is secured across the mounting posts 46 at a position above the screen member 50. As shown, the cap 52 has a circular top wall 53 with an interior generally planar surface 54. A pair of holes 56 extend through top wall 53 aligned with threaded holes 48. Cap 52 has an outer diameter exceeding the outer diameter of the screen member 50. Cap 52 has a vertical cylindrical side wall 58 having a length to overlie only a part of screen 50.

In the illustrated arrangement, the cap 52 is secured to the mounting posts 46 by attachment bolts 59 extending through holes 56 in top wall 53 and into threaded holes 48 in top surfaces 47 of the mounting posts 46. The top wall 53 of the cap 52 is held substantially parallel to the shoulder surface 36 with the cylindrical side wall 58 outwardly beyond the outer diameter of the screen member 50. The screen member 50 is thereby held between the surface 36 and the interior generally planar surface 54 of cap 52. The cap 52 thus closes the upper end of the cylindrical screen 50.

As will be appreciated, in the illustrated configuration the cap 52 serves to close the open end of screen member 50 against entry of insects or other debris. Thus, the screen member 50 and the cap 52 cooperatively prevent airborne contaminants from entering the inlet opening 40 while permitting air flow into the interior passage 28.

Once the screen member 50 is in position, it provides an air permeable barrier, upstream of inlet opening 40, to insects or other debris that may otherwise pass through the spaces between the mounting posts 46 that define inlet opening 40. At the same time, the screen member 50 preferably provides sufficient air permeability such that it does not substantially restrict communication between the interior passage 28 and the outside atmosphere. In this regard, it may be beneficial for the screen member to have open voids occupying about thirty percent (30%) or greater of the total screen area. That is, the ratio of open to solid area is at least 0.30. However, higher or lower open void percentages may be used if desired. By way of example only, and not limitation, one potentially desirable material for forming the screen member 50 is steel mesh having an open area of fifty to sixty percent (50-60%).

As shown, in the assembled condition, the sidewall 58 of the cap 52 overlies a portion of the screen member 50 in opposing spaced relation. In this regard, the inner diameter of the wall 58 of cap 52 is in close proximity to a portion of the exterior of the valve body 26 while nonetheless maintaining a sufficient space to maintain air flow to the screen 50 without substantial obstruction.

During the period of air flow, that is when valve 60 is open, air is pulled from the atmosphere and into the inlet opening 40 through screen member 50. The air enters the inlet opening 40, free of insects and other airborne debris which would otherwise pass into the interior passage 28. Once the pressure within the interior of the tank car has been increased to a desired level, the valve 60 is urged back to the normally closed condition until vacuum conditions reoccur.

Importantly, it is to be understood that the illustrated and described operational features of the valve assembly are exemplary only, and any number of other operating configurations may be utilized if desired. Accordingly, it is to be understood that the use of any and all examples, or exemplary language provided herein, is intended merely to better illuminate the invention and does not pose a limitation on the scope of the invention unless otherwise claimed.

No language in the specification should be construed as indicating any non-claimed element as essential to the practice of the invention. Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein.

What is claimed is:

1. A vacuum relief assembly for a containment vessel comprising:
a valve body having an interior wall defining a passage including an inlet opening and an outlet opening, said outlet opening being adapted for fluid communication with a containment portion of a containment vessel and said inlet opening being open to atmosphere, a normally closed valve, closing said passage and operable to selectively open said passage between said inlet opening and said outlet opening,
a screen member disposed upstream of said inlet opening, said screen being interposed between said inlet opening and the atmosphere.

2. A vacuum relief assembly as claimed in claim 1 wherein said body is generally cylindrical and includes a securement end portion configured to be secured to a containment vessel.

3. A vacuum relief assembly as claimed in claim 2 wherein said screen is generally cylindrical and surrounds said inlet opening.

4. A vacuum relief assembly as claimed in claim 3, wherein said valve body includes a shoulder surface extending radially outwardly from said valve body and said screen includes a lower end supported on said shoulder surface.

5. A vacuum relief assembly as claimed in claim 4, wherein said valve body includes a generally cylindrical upper wall portion extending upwardly from said shoulder surface and a plurality of mounting posts projecting upwardly from said sidewall portion defining open spaces therebetween and wherein said screen surrounds said open spaces.

6. A vacuum relief assembly as claimed in claim 5, wherein a cap is disposed at a position above said screen member in opposing relation to said shoulder surface such that said screen member is held between said cap and said shoulder surface.

7. A vacuum relief assembly as claimed in claim 8 wherein said cap includes a top wall defining an interior surface in contact with an upper end of said screen.

8. A vacuum relief assembly as claimed in claim 7, wherein said cap is secured to said mounting posts.

9. A vacuum relief assembly as claimed in claim 8 wherein said cap includes a generally cylindrical vertical side wall, said side wall overlying a portion of said screen in spaced relation thereto.

10. A vacuum relief assembly as claimed in claim 2 wherein said body includes a torque-acceptance configuration.

11. A vacuum relief assembly as claimed in claim 9 wherein said body includes a torque-acceptance configuration.

12. A vacuum relief assembly as claimed in claim 3 wherein said screen is a mesh made from metal or plastic.

13. A vacuum relief assembly as claimed in claim 11 wherein said screen is a mesh made from metal or plastic.

14. A vacuum relief assembly as claimed in claim 12 wherein said screen has open voids occupying at least thirty percent (30%) of the total screen area.

15. A vacuum relief assembly as claimed in claim 13 wherein said screen has open voids occupying at least thirty percent (30%) of the total screen area.

16. A vacuum relief assembly as claimed in claim 14 wherein said screen has open voids occupying from between fifty to sixty percent (50-60%) of the total area of said screen.

17. A vacuum relief assembly as claimed in claim 15 wherein said screen has open voids occupying from between fifty to sixty percent (50-60%) of the total area of said screen.
